(19) United States
(12) Patent Application Publication
(10) Pub. No.: US 2004/0003392 A1
(43) Pub. Date: Jan. 1, 2004

(54) Method and apparatus for finding and updating user group preferences in an entertainment system

(75) Inventors: Miroslav Trajkovic, Ossining, NY (US); Srinivas Gutta, Yorktown Heights, NY (US); Vasanth Philomin, Hopewell Junction, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/180,571

(22) Filed: Jun. 26, 2002

(51) Int. Cl. H04N 7/16; H04H 9/00; G06F 3/00; H04N 5/445; G06F 13/00; G06K 9/00

(52) U.S. Cl. 725/10; 382/115

(57) ABSTRACT

A system, method, and article of manufacture suitable for automatically generating recommendations of a set of entertainment options from a larger set of entertainment options based on user preferences for those options. In particular, the present invention relates to the field of automatically generating recommendations for viewing television programs based on past viewing patterns and preferences of a group of television viewers, all of whom are physically present in front of the television. The present invention creates a user group profile based on the expressed preferences of the user group or preferences implied by past viewing patterns of the user group. The recommendations may be based on the user group's preferences and viewing patterns for viewing during certain times of day or week or certain dates.

### BACKGROUND OF THE INVENTION

1. Field of the Invention

The present invention relates to the field of determining the preferences of a group of users of a device and configuring the device in accordance with the preferences of that user group. The present invention generates recommendations for a set of options based on the preferences of a group of users for those options, in particular, based on past patterns of option selection. More particularly, the present invention relates to the field of automatically generating recommendations for viewing television programs based on past viewing patterns and preferences of groups of television viewers, which groups are, from time to time, physically present in front of the television.

2. Description of Related Art

With regard to user interaction with complex devices and systems, in particular, with reference to broadcast, cable and satellite television, a user or group of users may have access to a hundred or more choices at any time. The time required to review the available options and decide upon, for example, the settings for a television entertainment system can easily exceed the time a user or group of users have available for use of the system. A recommender system becomes necessary to organize and present the content available based on past preferences of that user group.

As the choices of programming increase, numerous methods for providing information regarding the content of the programming have been proposed. For example, U.S. Pat. No. 6,115,057, to Kwoh et al., teaches extracting rating data from a program video segment, the rating data indicating a rating level of the program video segment.

Application Ser. No. 09/882,158 of Gutta et al., filed Jun. 15, 2001, discloses a method, system and article of manufacture for multi-user profile generation from the past viewing patterns and preferences of individual television viewers.

U.S. Pat. No. 6,020,883 to Herz et al. teaches developing customer profiles for recipients describing how important certain characteristics of the broadcast program are to each customer. The customer profiles may be clustered for combinations of customers expected to view the video programs at a particular customer location at particular times on particular days. From these profiles, an agreement matrix is calculated, embodying the attractiveness of each such program to each recipient based on his or her profile.

U.S. Pat. No. 5,585,865 to Amano et al. teaches receiving a television signal in which genre codes are included. Amano '865 teaches comparing the broadcast genre code with an entered genre code for all receivable channels and, if a program exists for which the genre codes match, tuning in that channel. Amano '865 also teaches tuning into channels having a past record of highest frequency of reception.

U.S. Pat. No. 4,931,865 to Scarampi teaches a method and apparatus for monitoring the television viewing acts of individuals by transmitting a signal toward the individual and detecting the reflection of the signal from the individual's eyes to determine the time intervals and total times the individual is viewing the television. The viewing information is correlated with the program information from the television.

U.S. Pat. No. 5,945,988 to Williams et al. teaches a method and apparatus for automatically determining and dynamically updating user preferences in an entertainment system. Williams '988 allows for a plurality of system users and provides for automatic detection of which one of the system users is currently using the entertainment system.

There is, however, no teaching or suggestion in the prior art for establishing the identity of a group of people in a viewing area, either in front of or within a certain distance of a television or other entertainment system, and creating a user group profile using the preferences of that group of users. The prior art does not teach or suggest a system which automatically detects and identifies users as a group and decides which programs are to be recommended or shown depending upon which programs are being transmitted during a time-frame, that further meet or exceed a rating using a user profile of the preferences of that user group.

### SUMMARY

The present invention comprises a system, method, and article of manufacture suitable for automatically generating recommendations of a set of preferred options for entertainment or, in general, for configuration of any complex device or system from a larger set of available options based on the preferences of a given group of users present in a predefined area. In an exemplary embodiment, the present invention relates to automatically generating recommendations for viewing television programs based on the past viewing patterns and preferences of a group of television viewers, all of the members of which are physically present in front of the television. The present invention creates a user group profile based on preferences expressed directly by the user group detected.

### BRIEF DESCRIPTION OF THE SEVERAL VIEWS OF THE DRAWING(S)

These and other features, aspects, and advantages of the present invention will become more fully apparent from the following description, appended claims, and accompanying drawings in which:

FIG. 1 is a generally perspective schematic view of an exemplary embodiment of the present invention;

FIG. 2a is a flow diagram of an exemplary method of the present invention; and

FIG. 2b is a flow diagram of an exemplary method of creating and maintaining the user group profile of the present invention.

### DETAILED DESCRIPTION OF A PREFERRED EMBODIMENT

In general, throughout this description, if an item is described as implemented in software, it can equally well be implemented as hardware.

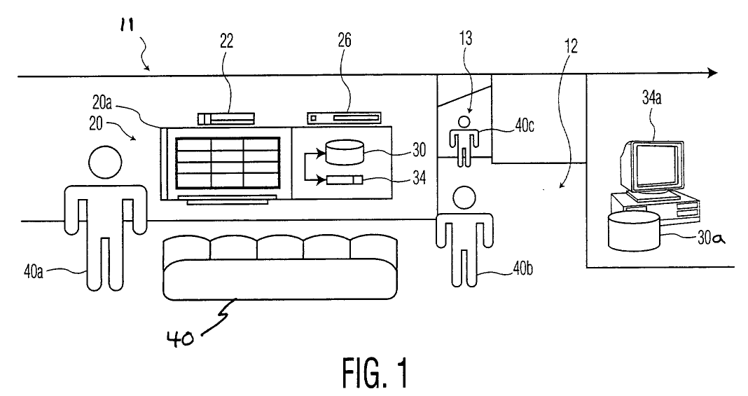

Referring now to FIG. 1, the present invention is suitable for use with an entertainment system 20 such as television 20a. Entertainment system 20, however, can include radio, other audio entertainment, broadcast and non-broadcast audio-visual entertainment such as cable or satellite or DVD systems, or the like. Entertainment system 20 comprises persistent data store 30 such as a hard drive or non-volatile RAM (NVRAM) capable of storing user group preference data for up to a corresponding plurality of entertainment system user groups, generally referred to herein by the numeral “40,” which included one or more users, such as 40a, 40b, 40c, etc. The user group preferences further comprise viewing histories for each user group 40. As used here, “viewing history” means an accumulation of entertainment options or other options for setting the parameters of operation of a complex system that a given user group 40 previously selected over some predetermined time frame. In a preferred embodiment, the system of the present invention may make an assumption that when user group 40 selects a particular entertainment option, user group 40 has reached a consensus regarding it and wants the system to recommend similar options in the future.

Detection system 22 senses each member of a user group when each member of a user group 40 such as user group member 40a or 40b is in a predetermined viewing area 11 proximate to television 20a. As used herein, “viewing area” may include not only the physical space proximate television 20a such as viewing area 11 but one or more adjacent viewing areas as well such as viewing areas 12 and 13 desired by a user group 40 with authority to make set viewing area 11 boundaries.

Detection system 22 may be of any such system as will be familiar to those of ordinary skill in the detection arts, including by way of example and not limitation input devices such as a television remote, biometric devices, set top boxes having recognition systems, voice recognition systems, and the like, or a combination thereof. As used herein, “biometric devices” may include a voice recognition system, a fingerprint recognition system, a handprint recognition system, and the like, or combinations thereof. “Face and Hand Gesture Recognition Using Hybrid Classifiers” by Gutta et al. and published in the Proceedings of the Second International Conference on Automatic Face and Gesture Recognition by the Computer Society of the Institute of Electrical and Electronic Engineers, Inc. and “Maximum Likelihood Face Detection” by Colmenarez et al. published in the Proceedings of the Second International Conference on Automatic Face and Gesture Recognition by the Computer Society of the Institute of Electrical and Electronic Engineers, Inc. are two examples of biometric recognition prior art.

Profile processor 34 is communicatively coupled to persistent data store 30 and detection system 22. As used herein, “profile processor” comprises a computer such as personal computer 34a, with its own persistent data store 30a,a microprocessor based system such as a microprocessor system embedded within or directly built into an entertainment system 20 such as profile processor 34, an application specific integrated circuit, an external device such as set top box 26 comprising a microprocessor based system, and the like, or any combination thereof. Profile processor 34 is capable of monitoring interaction of user group 40 with entertainment system 20; recording that interaction with entertainment system 20 as well as the viewing history for each user group 40; and creating, manipulating, storing, and maintaining user profiles in persistent data store 30.

Using detection system 22, profile processor 34 automatically detects which users 40 of the plurality of entertainment system users 40a, 40b, etc. are currently using entertainment system 20 or are within viewing area 11 of entertainment system 20. Using the detected user group 40, profile processor 34 automatically creates a user group profile based on the viewing history of that user group 40.

Each user group profile may comprise a viewing history as well as preferences for the user group 40. Additionally, users 40a, 40b, etc. with appropriate access rights may be allowed to modify the user group profile, by, by way of example and not limitation, deselecting a set of predefined preference categories. These categories may include genre of entertainment options preferred, e.g. type of music or television program type. Additionally, a user group 40 may rank order entertainment options by user group preference, time of day viewing preferences or the like or may make modification to a user group profile effective only during certain times of the day or week, or any combination thereof. For example, a user group made up of a given young adult 40a with small children 40c may develop a viewing history and user group preference for children's cartoon programming effective during certain times of day when the small children 40c are present with the young adult in the user group within the viewing area 11.

Entertainment options that rate at or above a threshold value may be considered a “positive” program for a user group 40. Accordingly, those entertainment options that do not rate at or above a threshold value may be considered a “negative” program for a user group 40. Given the viewing history of a user group 40, the system of the present invention generates a set of negative entertainment options such as by sampling an available database of all entertainment options, where the database is of the type familiar to those of ordinary skill in the software programming arts.

In an exemplary embodiment, the present invention uses a uniform random distribution to generate the negative entertainment options. By way of example and not limitation, the exemplary method selects each entertainment option from a database of all available entertainment options for entertainment options in the database that are not in the set of positive entertainment options for user group 40. This generation of the negative set of entertainment options may also be limited, for example, by a predetermined time frame, such as within a week from that day.

Additionally, an adaptive technique may be used, such as disclosed in U.S. patent application Ser. No. 09/819,286, by Gutta, et al., for An Adaptive Sampling Technique for Selecting Negative Examples for Artificial Intelligence Applications, filed Mar. 28, 2001, which is incorporated by reference in its entirety herein. The adaptive sampling technique picks entertainment options that are closer to the positive entertainment options and uses implicit, explicit, and feedback techniques for generating recommendations for a user group 40. Implicit techniques involve a system's being aware of what entertainment options appeal to each user group 40, e.g. what each user group watches or listens to; capturing the entertainment option preference patterns of the user group 40; and recommending entertainment options based on those captured pattern options. As used herein, “capture” includes, by way of example and not limitation, storing predetermined data in the user group profile for the user group 40 such as in the viewing history of the user group 40. Explicit techniques involve having a user group 40 specify viewing preferences and then using these specified preferences to recommend entertainment options to a user group 40. A third technique involves having a system elicit specific feedback from a user group 40 and then generate a set of recommendations based on the feedback from the user group 40. Additionally, a technique may be used that combines all the above.

In the operation of an exemplary embodiment, as opposed to the prior art, the present invention addresses making a set of entertainment option recommendations based on a single user group 40. Accordingly, in one exemplary embodiment, the system first identifies each of the users 40a, 40b, 40c, etc. in viewing area 11 and then presents entertainment option recommendations limited to those entertainment options having a rating by user group 40 in viewing area 11 based upon past viewing history developed while the user group was physically present in the viewing area 11.

When all users 40a, 40b, 40c, etc. in viewing area 11 are detected and identified, a profile for the user group 40 of all the detected and identified viewers is identified and retrieved for further processing. If all users 40a, 40b, 40c, are not found, no correlation between the users and an identified user group is made and that user group may be represented by a default profile until a viewing history is established for it. For second and subsequent uses of the system by that user group, a user group profile that reflects it's the preferences of that user group and a list of entertainment option recommendations is generated and made available to the user group 40 in viewing area 11.

The creation of the user group profile may be by implicit, explicit, or feedback techniques or any combination thereof. The available entertainment options are retrieved from a database or other source of available entertainment options for a given time frame, e.g. currently or currently through the next two hours, and analyzed against the user group profile to create a set of values for entertainment option recommendation. Entertainment options are selected from the set of all or a predetermined subset of all available entertainment options such as by recommending only those entertainment options being transmitted during the selected time-frame that are at or above a predetermined threshold value. In currently envisioned alternate embodiments, a user group can be presented with a display indicating only the recommended options, all options in which recommended options are distinguishable such as visually, or a configurable set of recommended, positive options as well as non-recommended, negative options. Only when an entertainment option is rated at or above a predetermined threshold value by a user group 40 will that entertainment option be recommended.

Furthermore, the user group profile generated from the viewing history may vary as a function of time of day, day of the week or month of the year, e.g. a profile for user group 40 may be different at night from during the day.

By way of example and not limitation, an entertainment system may be used by two users. The first user likes sports and politics, but occasionally watches dramatic programs. The second user watches only dramatic programs. Whenever they watch together, which is 80% of their viewing time, they watch dramatic programs. The present invention will identify three user groups and create three distinct user group profiles, one for the first and second user watching together, one for the first user watching alone, and one for the second user watching alone. The recommender of the present invention will then present to the first and second user watching together choices which represent that group's actual preference for dramatic programs. The first user watching alone will be presented with choices which represent his or her actual preference for sports and politics, and to the second user watching alone, the choices presented will represent his or her actual preference for dramatic programs.

As discussed above, in addition to viewing histories, the system can use other attributes in its decision processes. By way of example and not limitation, the preferences of a given user group 40 may change based on time of day. For example, if a mother and her three year old child watch cartoon programs together during certain hours, in one embodiment cartoons would be the only entertainment options that would be highly recommended by their user group profile during those hours and would be displayed even though those entertainment options may not be highly rated for the same user group at other times of day.

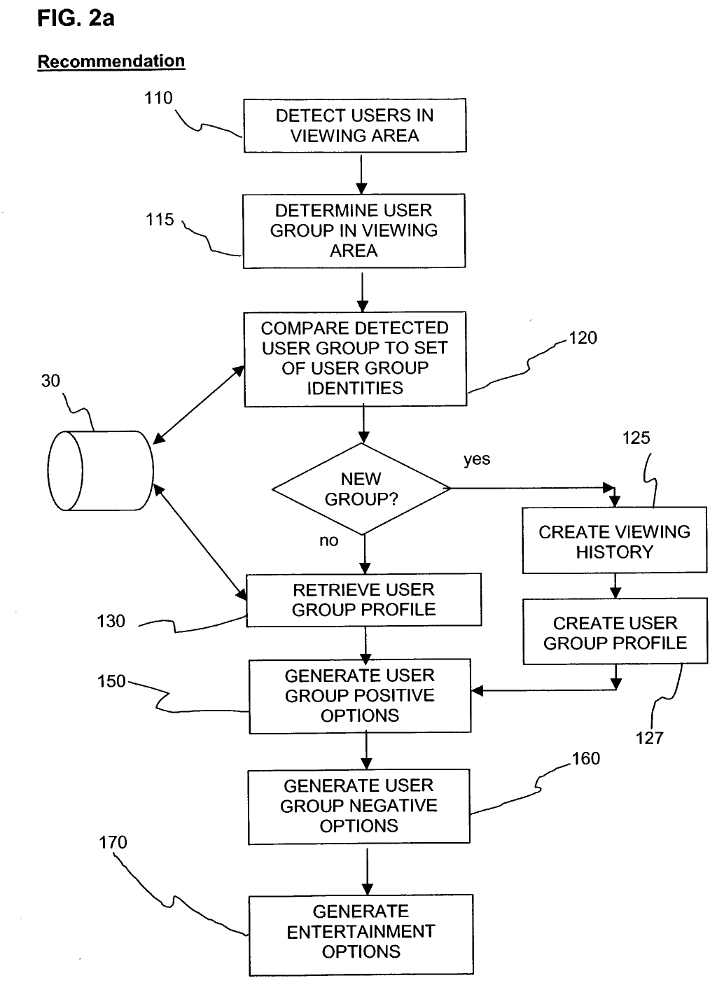

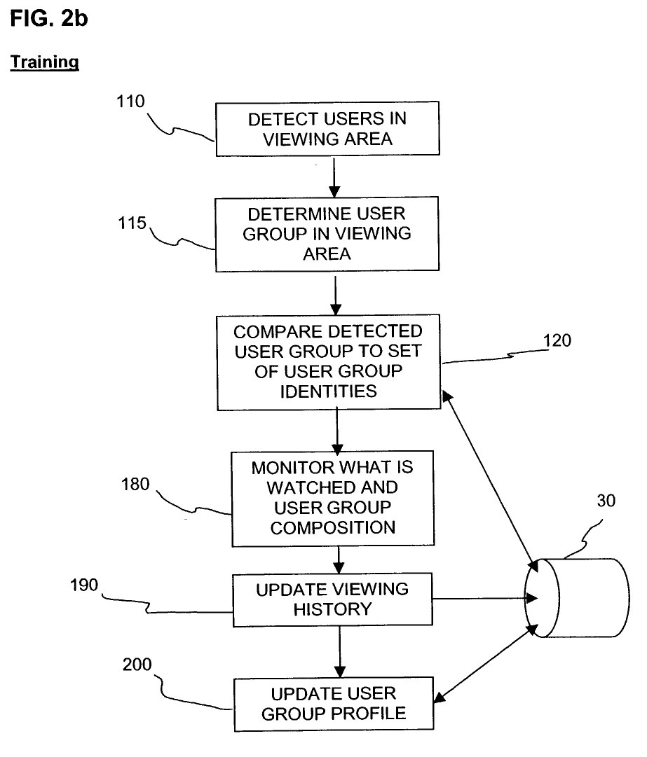

Referring to FIG. 2a, when television 20a is powered on or otherwise triggered, such as by a timer, detection system 22 detects 110 users 40a, 40b, 40c, etc. who are within predetermined viewing area 11.

Profile processor 34 then determines 115 the identity of the detected user group 40. In an exemplary embodiment, the set of identities of the detected user group 40 is compared 120 against a set of user group identities stored in persistent data store 30. As noted above, persistent data store 30 may be a part of television 20a or may be accessible to the television 20a such as a hard drive on personal computer 34a operatively connected to the television by connection means familiar to those of ordinary skill in the data communication arts.

The profile for the detected users watching together as a user group 40 is then retrieved 130 from persistent data store 30. For a user group 40 which cannot be identified or a group of users 40a, 40b, etc. which otherwise had no accessible profile, a viewing history record is created 125 and a default profile may be assigned. A user group profile is developed 127 as data on user group preferences becomes available and replaces the default profile, if a default profile is used.

Currently, several techniques of creating a user group profile are envisioned although others will be familiar to those of ordinary skill in the computer arts.

In a first technique, a user group profile reflecting entertainment option preferences expressed in the viewing history with the greatest arithmetic value are presumed to be entertainment options having the greatest appeal to the user group 40 in viewing area 11.

In a second technique, those components of each viewing history of each detected and identified user group 40 that appear with a frequency equal to or exceeding a predetermined threshold value are presumed to be entertainment options having the greatest appeal to the user group 40 in viewing area 11.

From the user group profile, the system generates 150 a set of composite positive entertainment options. Generation of the composite positive entertainment option set may be accomplished by numerous techniques as will be familiar to those of ordinary skill in the software programming arts including using uniform random distribution whereby a user group 40 may be allowed to select an entertainment option from a database of all available entertainment options for every entertainment option in the positive set. This may include making sure the entertainment option that has been picked is not part of the positive set and occurs from the same time frame, such as within a one week period. Alternatively, generation of the composite positive entertainment option set may be accomplished by an adaptive sampling technique which selects entertainment options that are closer to the positive entertainment options. Methods for adaptive television program recommendations based on a user profile are discussed in Adaptive TV Program Recommender, U.S. Ser. No. 09/498,271, filed Feb. 4, 2000, incorporated by reference in its entirety herein.

In a further alternative, generation of the composite positive entertainment option set may use implicit techniques, explicit techniques, feedback techniques, or a combination thereof.

Additionally, a set of negative entertainment options may be generated 160 by sampling the database of all entertainment options. The set of negative entertainment options may be stored for future use.

Once the sets of positive and negative programs are created, scores for each member of the sets may be generated 170 from the user group profile. As used herein, “scores” comprises numerical values associated with each member of the sets of positive and negative entertainment options by which each member of the sets of positive or positive and negative entertainment options are able to be gauged against other members of that set and/or against a predetermined threshold for use in generating recommended members of the set. In a currently preferred embodiment, scores are generated only for positive entertainment options. In a further exemplary embodiment, recommendations may be generated from the set of entertainment options matching a score threshold but limited to a predetermined time frame.

Additionally, one or more members 40a, 40b, 40c of the user group 40 may be designated as having rights, such as access rights or supervisory rights, that are different than the rights of other members of the user group 40. By way of example and not limitation, a user group member 40b may be enabled to alter rules and weighting methods, add to or modify the user group profile, or the like, whereas users 40a and 40c may not.

Referring to FIG. 2b, when television 20a is powered on or otherwise triggered, such as by a timer, detection system 22 detects 110 users 40a, 40b, 40c, etc. who are within predetermined viewing area 11. Profile processor 34 then determines 115 the identity of the detected user group 40. In an exemplary embodiment, the set of identities of the detected user group 40 is compared 120 against a set of user group identities stored in persistent data store 30. The programs that are watched by the user group and composition of the user group are monitored 180. The data obtained is stored to update 190 the viewing history in the persistent data store 30, and the user group profile is updated 200.

The described embodiments of the invention are only considered to be preferred and illustrative of the inventive concept. The scope of the invention is not to be restricted to those embodiments. Various and numerous other details, materials and arrangements may be devised by one skilled in the art without departing from the spirit and scope of this invention. It is intended by the appended claims to cover any and all applications, modifications and embodiments within the scope of the present invention.

The claimed invention is:

1. An apparatus useful with a system which has a number of variables that are set to accommodate the preferences of a group of users, the apparatus comprising:
a. a persistent data store having a plurality of storage locations to store a plurality of user preference data for a corresponding plurality of system user groups, wherein individual storage locations are dedicated to store user preference data for each one of the plurality of system user groups;
b. a user group detection system; and
c. a profile processor, communicatively coupled to the persistent data store and the user group detection system, the profile processor programmed to:
i. automatically detect which user group of the plurality of system user groups is currently within a predetermined viewing area; and
ii. automatically create a user group profile, useful for generating a set of recommended options from a set of available options, the user profile being based on the user preference data for the user group currently within the predetermined viewing area.

2. The apparatus of claim 1 wherein the system which has a number of variables that are set to accommodate the preferences of a group of users is an entertainment system.

3. The apparatus of claim 1 wherein the user detection system comprises a computer vision system, a voice recognition system, a fingerprint recognition system, a handprint recognition system, and an input device capable of transmitting at least one unique input.

4. The apparatus of claim 3 wherein the computer vision system identifies faces in the detected imagery.

5. The apparatus of claim 1 wherein the user detection system comprises a computer vision system and an input device capable of transmitting at least one unique input.

6. The apparatus of claim 5 wherein the computer vision system identifies faces in the detected imagery.

7. The apparatus of claim 1 wherein the profile processor is further programmed to monitor interaction of user groups with the system, selectively store in a viewing history a predetermined portion of each interaction between a user group and the system, and selectively retrieve interactions from the viewing history.

8. The apparatus of claim 7 wherein the profile processor is further programmed to:
a. create at least one value relating to the viewing history of a user group within that user group's profile; and
b. create a set of recommended choices for the user group profile based at least in part on each detected user group's viewing history for interaction choices similar to or the same as the interaction choices in the detected user group's viewing history.

9. An entertainment system, comprising:
a. at least one entertainment system component providing programming available to at least one user, the programming being received via at least one input to the entertainment system component;
b. a persistent data store having a plurality of storage locations to store user preference data for a corresponding plurality of entertainment system user groups, wherein at least one unique storage location is dedicated to store the user preference data for a unique corresponding system user group; and
c. a profile processor, operatively in communication with the at least one entertainment system component, the persistent data store, and a user group detection system, the profile processor programmed to:
i. automatically detect which user group of the plurality of entertainment system user groups are currently within a predefined viewing area;
ii. automatically create a user group profile based on the user preference data for the user group currently detected within the predefined viewing area; and
iii. dynamically adjust operating parameters for the entertainment system in response to the user group profile.

10. A method for creating a user group profile for a user group comprising a plurality of users, the method comprising:
a. automatically detecting which of a plurality of users are currently within a predetermined viewing area;
b. determining an identity of a user group consisting of the detected plurality of users;
c. for the identified user group,
i. comparing the identified user group's identity against a first predetermined portion of user group data stored in a persistent data store; and
ii. retrieving a second predetermined portion of user group data from the persistent data store for the identified user group; and
d. generating a user group profile from each of the second predetermined portions of user data.

11. The method of claim 10 further comprising creating a set of recommended entertainment options based on the user group profile from a set of available entertainment options.

12. The method of claim 10 wherein the user group profile may be generated by an individual who has authority to generate user group profiles for user groups which are present but who have no profile.

13. The method of claim 10 further comprising:
e. accumulating a viewing history for each detected user group, the viewing history comprising positive entertainment options;
f. adjusting the user group profile using the positive entertainment options in the viewing history wherein each positive entertainment option in the user group profile reflects a sum of occurrences of that positive entertainment option in the viewing history;
g. generating negative entertainment options for each positive entertainment option in the composite user profile;
h. determining which entertainment options available in a predetermined time frame are positively rated by the user group profile; and
i. generating a score of each positive entertainment option and negative entertainment option in the user group profile.

14. The method of claim 10 further comprising:
e. generating a set of positive entertainment options from a set of available entertainment options for the available entertainment options that meet or exceed a predetermined threshold value of positive entertainment options in the user group viewing history; and
f. generating a set of negative entertainment options by sampling the set of available options that do not meet the predetermined threshold value of positive entertainment options in the user group viewing history.

15. The method of claim 14 wherein step (f) further comprises using a uniform random distribution to create a set of negative options.

16. The method of claim 14 further comprising:
g. allowing a user group to select an entertainment option from the set of positive entertainment options; and
h. preventing selection of an available entertainment option for entertainment options that are members of the set of negative entertainment options.

17. The method of claim 16 wherein step (h) further comprises restricting negative entertainment options to those that occur within a predetermined time frame.

18. The method of claim 14 wherein step (e) further comprises using an adaptive sampling technique to select entertainment options from all available entertainment options such that the selected entertainment options match preferences in the composite user profile within a predetermined range.

19. The method of claim 14 further comprising:
g. generating entertainment option recommendations based on available entertainment options and the set of positive entertainment options using implicit selection techniques, explicit selection techniques, feedback selection techniques, or a combination thereof.

20. The method of claim 19 wherein the implicit selection techniques comprise capturing the user groups' entertainment option selection patterns and generating entertainment option recommendations based on the user group's entertainment option selection patterns.

21. The method of claim 19 wherein the explicit selection techniques comprise having the user group explicitly input each of the user group's entertainment option preferences and generating entertainment option recommendations based on a composite of the user group's explicit entertainment option preferences.

22. The method of claim 14 further comprising:
g. capturing user groups' entertainment option selection patterns;
h. accepting at least one of the user group's explicit input of the user group's entertainment option preferences; and
i. generating entertainment option recommendations based on the user groups' entertainment option selection patterns and the user group's explicit entertainment option preferences.

23. The method of claim 14 wherein each user group profile may further comprise a weighting factor which can vary as a function of the time of day or calendar time.

24. In an entertainment system including a program processor operatively connected to a persistent data store, a program output device, an audio input device, a user detection device, and a video input device, a method for automatically configuring the entertainment system for a plurality of identified system users, the method comprising:
a. detecting which users are currently within a predetermined viewing area;
b. determining a detected user group consisting of the detected users;
c. determining an identified user group from the detected user group, the identified user group having user preference data stored from the detected user group in the persistent data store;
d. retrieving the user preference data corresponding to the identified user group from the persistent data store;
e. creating a user group profile using the retrieved user preference data;
f. scanning programming information for available entertainment options which match the user group profile within a predetermined range of matching values; and
g. adjusting the entertainment system in accordance with the user group profile and available entertainment options.

25. A computer program embodied within a computer-readable medium created using the method of claim 10.

26. A computer program embodied within a computer-readable medium created using the method of claim 24.
